(19) United States
(12) Patent Application Publication
(10) Pub. No.: US 2013/0105193 A1
(43) Pub. Date: May 2, 2013

(54) FLEXIBLE AND MOLDABLE MATERIALS WITH BI-CONDUCTIVE SURFACES

(71) Applicant: The Regents of the University of California, Oakland, CA (US)

(72) Inventors: Adam Kirk, Berkeley, CA (US); Christine Ho, Fremont, CA (US); Alejandro de la Fuente Vornbrock, San Carlos, CA (US); David Garmire, Honolulu, HI (US)

(73) Assignee: THE REGENTS OF THE UNIVERSITY OF CALIFORNIA, Oakland, CA (US)

(21) Appl. No.: 13/660,783

(22) Filed: Oct. 25, 2012

Related U.S. Application Data
(63) Continuation of application No. PCT/US2011/035039, filed on May 3, 2011.
(60) Provisional application No. 61/330,804, filed on May 3, 2010.

(51) Int. Cl. H01B 7/04

(52) U.S. Cl. CPC H01B 7/04
USPC 174/68.1

(57) ABSTRACT

A flexible, moldable material is provided with bi-conductive surfaces that can be fabricated using simple, cost-effective, and scalable deposition processes. The material is a composite structure composed of two conductive or semi-conductive sheets sandwiching a thin polymer insulator, all bonded together at their interfaces. The two functionalized sheets are made of conductive or semi-conductive particles dispersed through a flexible polymer. In one embodiment, a protective coating over the outer conductive sheets is applied to improve the durability of the composite structure. The material can be patterned into custom shapes and patterns with sizes ranging from meso-scale (millimeters) to macro-scale (meters) dimensions. The thicknesses of the components can also be tailored to be thin, such as a few hundred microns, yet the material maintains very good durability.

### CROSS-REFERENCE TO RELATED APPLICATIONS

This application a 35 U.S.C. §111(a) continuation of PCT international application number PCT/US2011/035039 filed on May 3, 2011, incorporated herein by reference in its entirety, which is a nonprovisional of U.S. provisional patent application Ser. No. 61/330,804 filed on May 3, 2010, incorporated herein by reference in its entirety. Priority is claimed to each of the foregoing applications.

The above-referenced PCT international application was published as PCT International Publication No. WO 2011/140119 on Nov. 10, 2011 and republished on Mar. 1, 2012, and is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to functionalized particle polymer matrix composites, and more particularly to a flexible and moldable laminate of nanoparticle functionalized polymeric nanocomposite layers separated by a flexible insulating layer.

2. Description of Related Art

Advances in sensor capabilities are often driven by advances in materials science and fabrication methods. The detection capability of a sensor is largely defined by the physical characteristics of the component materials and signal processing requirements. Recent years have seen a growing demand for sensors that monitor or quantify the shape of a surface, for example, in the areas of motion capture and user-interface devices. Practical applications driving this demand include activity monitoring for the elderly, soldiers, and first responders, augmented reality interfaces, sports medicine and physical therapy, and alternative input methods for gaming systems and smart phones. Prior methods that capture surface shape include motion capture rooms, light detection and ranging (LIDAR), stereovision, and specially manufactured electrodes in the material (virtual-reality gloves and clothe). However, motion capture rooms and LIDAR currently are prohibitively expensive for general and personal use. LIDAR and stereovision have difficulties with handling occlusions due to line-of-sight constraints, absorbing materials, and low-level illumination.

Current approaches for monitoring the shape of a surface include placing piezoresistive strips, resistivity changing strips, or other strain-gauge sensor technologies on gloves or clothing. However, piezoresistive strips by themselves appear to suffer from high noise levels due to common-mode noise, potentially stemming from wiring constraints and the triboelectric or electromechanical interaction of the materials. There are also calibration issues that arise if the strips are directly embedded in cloth due to the difficulty in controlling layer thickness and the interactions that occur between the textile and strain-gauge materials.

Strain-gauge approaches in the art focus on using a single strain gauge in a linear fashion. To extract information regarding the curvature over a surface, several strain gauges need to be placed at orthogonal angles to each other. One significant difficulty with this strain-gauge approach is that the number of electrodes and attached wires scales linearly with the number of strain gauges. Unfortunately, highly conductive lines are costly to make both flexible and durable, and processing to add in numerous lines to a sheet can both affect the mechanical bending properties of the surface and substantially drive up manufacturing costs.

Accordingly, there is a need for a functionalized material that is inexpensive, easy to fabricate, durable, reliable and does not require a calibrated environment. The present invention satisfies these needs as well as others and is generally an improvement over the art.

### BRIEF SUMMARY OF THE INVENTION

The present invention is directed to materials and methods for producing a flexible or moldable laminate material with bi-functionalized surfaces that can be used in a variety of applications including material composites for shielding electronic devices and sensors as well as the production of flexible capacitors and strain gauges and similar devices.

The construct material can be fabricated using simple, cost-effective, and scalable deposition processes. The material is a composite structure composed of at least two conductive sheets that sandwich a thin polymer insulator layer that are all bonded together at their interfaces. The two conductive sheets are made of conductive particles or semi-conductive particles dispersed through a flexible polymer.

The bi-conductive layers of the construct are preferably formed from slurry of a polymer, a curing agent, particulates and a solvent. The preferred solvent is toluene. However, other solvents with similar properties to toluene that can be used include xylene, n-methyl pyrollidone (NMP), and acetone.

In one embodiment, poly di-methyl silane (PDMS) or polyvinylidene fluoride (PVDF) are selected as polymers and functionalized with particles. These polymers without the particulates can also be used to form the central insulating polymer layer as well. Other possible polymers include PTFE, PVA, cellulose, or other insulating material that is flexible in nature. In addition, many of these polymers are available in a variety of forms, such as a range of molecular weights, which can ultimately alter the properties of the materials. However, the size and possible side chains of the polymers are not important so long as the cured polymer layers are flexible and functionalized i.e. conductive, insulate or protective as described.

Functional particulates that can be used include conductive particles, such as inexpensive activated carbons, graphite, carbon nanotubes, and metallic powders, fibers, and nanoparticles of zinc, silver, nickel, and nickel-coated carbon. Alternatively, particles can be added to increase the dielectric properties of the polymer material, such as insulating powders, fibers, and nanoparticles including semi-conductors like titanium dioxide, zinc oxide, and other metal oxides with similar properties. Other conductive particles of similar properties would also be compatible with this system.

In an alternative embodiment, the two outer active surfaces can be covered with an outer protective coating that is flexible to improve durability and that will shield and protect the active layers. For example, the outer surface can be a layer of insulating polymer such as used in the center of the laminate construct. This electrically insulative protective layer can not only protect the structural integrity of the conductive layers, the protective layer can also electrically insulate the conductive layers from outside noise or other interference. In another embodiment, only one surface is covered with a protective layer because the laminate is placed on a substrate that protects the bottom active layer.

It will be seen that such a versatile, flexible, bi-conductive material can be applied to a variety of applications. There are three main categories of practical uses of the laminate constructs of the invention, including shielding, flexible capacitors, and strain gauges.

Since the materials can be directly applied to many different shaped substrates, the laminate can be formed onto objects such as wires, walls and other objects that need to be shielded from damaging or interfering electromagnetic radiation. Similarly, sheets of the tri-layer material can be fabricated separately and attached to the periphery of an object, which then can be used to shield things such as a sensitive device or the walls of a room.

The structure of the laminate construct can also be used to create a flexible capacitor. With the ability to tailor the lateral and vertical dimensions of the conductive and insulating layers, the resulting capacitance of the material can be customized for a given application. This may be a complementary technology to the developing field of flexible circuits because of the incorporation of low-cost materials and simple fabrication processes.

If measured independently, the resistance of each of the material's bi-conductive layers will change with the relative flexure and curvature changes experienced by the material. By utilizing this behavior, the material can be used as a flexible strain gauge by correlating the relative changes in strain with resistance chances within the system. Furthermore, the laminate material can act as a stand-alone strain gauge or can be applied to a surface of interest to infer its relative change in shape. This provides opportunities in a wide variety of fields requiring strain and shape-change sensing, including health and structural integrity monitoring.

Accordingly, an aspect of the invention is to provide a flexible three-layered bi-conductive sheet that can be used in the formation of sensors, capacitors or strain gauge based devices.

Another aspect of the invention is to provide a system for monitoring changes in surface shape that is portable, inexpensive, durable, and works in many places where traditional shape monitoring techniques would fail.

Another aspect of the invention is to provide a laminate that is inexpensive, easy to manufacture, durable and adaptable to a wide variety of uses.

A further aspect of the invention is to provide a bi-conductive sheet and system that is ideally suited to monitoring large-scale surface deformations on surfaces like cloth without excessive wiring or the need for special purpose equipment.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a schematic diagram of a cross-section of one bi-conductive construct according to one embodiment of the invention.

FIG. 2 is a schematic diagram of a cross-section of an alternative embodiment of bi-conductive construct according to one embodiment of the invention with top and bottom protective layers that protect the active layers.

FIG. 3 is a schematic diagram of the bending of the construct of FIG. 1 and Example 2 showing that a layer of material stretches at the top surface and compresses the bottom surface. The stretched layer (inset) contracts in the lateral and out-of-plane directions according to Poisson's ratio, v.

FIG. 4 is a schematic diagram of a top view with a representation of an equivalent circuit superimposed on a sheet of material. Note that three current pathways are supplied in this example.

FIG. 5 shows node positions and normal vectors that are updated using the local curvature information in the embodiment described in Example 2.

### DETAILED DESCRIPTION OF THE INVENTION

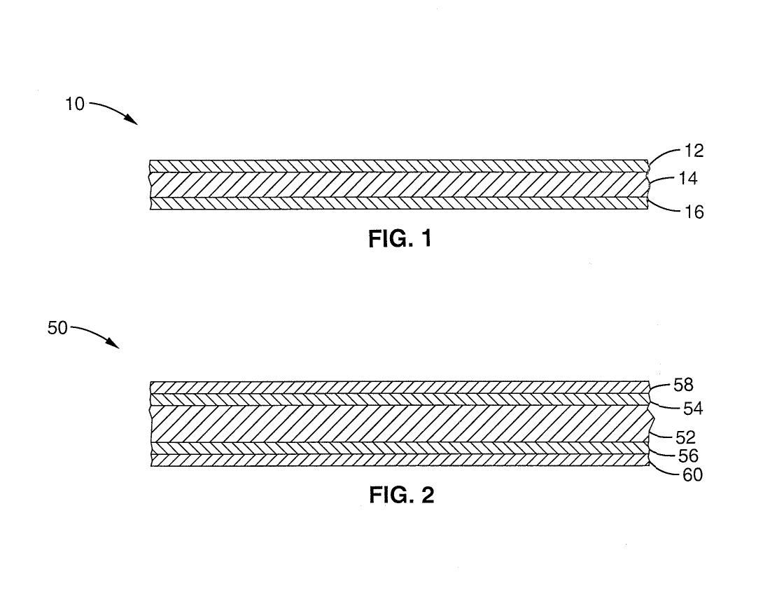

Referring more specifically to the drawings, for illustrative purposes one embodiment of the present invention is depicted in the materials and methods generally shown in FIG. 1 through FIG. 5. It will be appreciated that the materials and laminate compositions and the methods for manufacture and use may vary as to the specific steps and sequence and the laminate constructs may vary as to structural details, without departing from the basic concepts as disclosed herein. The steps depicted and/or used in methods herein may be performed in a different order than as stated. The steps are merely exemplary of the order these steps may occur. The steps may occur in any order that is desired, such that it still performs the goals of the claimed invention.

The present invention provides a flexible, moldable material with bi-conductive surfaces. The material can be made into a standalone sheet, or conformably attached directly onto an existing surface. The deposition of all the components are compatible with low-cost, scalable, high-throughput solution-based fabrication processes, and conceivably the material can be patterned into custom shapes and patterns with sizes ranging from meso-scale (millimeters) to macro-scale (meters) dimensions. The thicknesses of the components can also be tailored to be thin, such as a few hundred microns, yet the material maintains very good durability.

Turning now to FIG. 1, a preferred embodiment 10 of a laminate construct 10 according to of the present is illustrated schematically and is not intended to be drawn to scale. The laminate 10 has a central insulating layer 14 that is disposed between a top outer layer 12 and a bottom outer layer 16. The center insulating layer 16 is preferably a flexible insulating polymer that can be the same polymer as used with the top conductive layer 12 or the bottom layer 16 for convenience in the manufacturing process. However, the insulating layer can also be formed from PTFE, PVA, cellulose, or other insulating material that is flexible in nature. In one embodiment, the insulating layer 14 includes particulates of an insulator to improve its function as an insulator.

The top functional layer 12 and the bottom functional layer 16 are preferably formed from poly di-methyl silane (PDMS) or polyvinylidene fluoride (PVDF) polymers that are functionalized with dispersed conductive or semi-conductive particles. Other preferred polymers include polytetrafluoroethylene (PTFE) and polyvinyl alcohol (PVA). Many of these polymers are available in a variety of forms, such as a range of molecular weights or branched side chains, which can ultimately alter the final properties of the materials. However, such alternative forms of polymer may be suitable so long as they are flexible after curing and durable.

The top layer 12 and bottom layer 16 are preferably functionalized with nanoparticles that are selected based on the desired function of the layer that is determined by the ultimate use of the laminate.

Functional particulates that can be used include conductive particles, such as graphite, inexpensive activated carbons, carbon nanotubes, and metallic powders, fibers, and nanoparticles of zinc, silver, nickel, and nickel-coated carbon or semiconductive particles such as titanium dioxide and zinc oxide and other metal oxides and semiconductors with similar properties.

Alternatively, particles can be added to increase the dielectric properties of the polymer material of the insulating layer 14 such as insulating powders, fibers, and nanoparticles including magnesium oxide, alumina, feldspar, clay and quartz.

The preferred weight ratios of the polymer to particulates is within the range of approximately 4:1 to 5:1 polymer to particulate and about 20:1 by weight of polymer to curing agent, which are used to form a slurry for deposition as a polymer sheet. The bi-conductive layers of the construct are preferably formed from slurry of a polymer, a curing agent, particulates and a solvent. The preferred solvent is toluene. However, other solvents with similar properties to toluene that can be used include xylene, n-methyl pyrollidone (NMP), and acetone. The deposited sheet of polymer is typically cured by exposure to heat.

Referring now to FIG. 2, an alternative embodiment of a laminate 50 according to the invention is depicted schematically. In this embodiment, the center insulating core layer 52 has a top active layer 54 and a bottom active layer 56 formed from cured functionalized particulate filled polymer layers. The active top layer 54 and the active bottom layer 56 have a top protective layer 58 and a bottom protective layer 60. The top and bottom protective layers 58, 60 are preferably formed from flexible polymers that will protect the surface of the top and bottom active layers 54, 56 while not significantly interfering with the flexibility of the overall laminate 50. In one embodiment, the top and bottom protective coatings 58, 60 are formed from the same insulating material used to form the central core layer 52. The active layers 54, 56 are insulated on both sides in this embodiment. In another embodiment, only the top or bottom protective layer is applied to the laminate because one active layer is ultimately placed on a substrate and protected with only the top side conductive layer in need of a protective coating.

The active layers, 12, 16 or 54, 56 are typically constructed with the same polymers and particulates in identical amounts so that the layers are essentially identical. However, in one embodiment, the top active layer 12 or 54 is made with particulates of one type and the bottom active layer 16 or 56 is made with particulates of a different type. In another embodiment, the polymers that are used in the top active layers 12 or 54 are different from the polymers used by the bottom active layers 16, 56 thereby giving the resulting sheet sides with discreet characteristics.

Each of the layers of polymer that are used to produce the laminates of FIG. 1 or FIG. 2 are preferably between approximately 100 μm and approximately 200 μm in thickness. The outer protective layers can between 50 μm and approximately 100 μm. Accordingly, the typical laminate structure that is produced will range from approximately 500 μm and approximately 1 nm in thickness.

Because this laminate is inexpensive, easy to fabricate, and does not require a calibrated environment, it is well suited to a wide range of applications. Examples of such applications include user input and safety monitoring. One can imagine wearing clothing with these sensors embedded, which would enable the user to interact with devices using only gestures. Alternatively, interested parties could monitor the behavior of people or objects in high stress environments.

The invention may be better understood with reference to the accompanying examples, which are intended for purposes of illustration only and should not be construed as in any sense limiting the scope of the present invention as defined in the claims appended hereto.

### Example 1

In order to illustrate the methods for fabrication and the functionality of the resulting bi-conductive material construct, a composite structure composed of two outer sheets of conductive particles dispersed in a flexible polymer sandwiching a thin polymer layer was produced.

The conductive material layers were produced from 20 grams of poly di-methyl silane (PDMS); 1 gram of PDMS curing agent; 5 grams of Acetylene black (AB) and 57.7 grams of Toluene solvent. In this illustration, the non-conductive center material was produced from 20 grams of poly di-methyl silane (PDMS) and 1 gram of PDMS curing agent.

A slurry of conductive material was prepared as follows:

1) PDMS and curing agent were mixed rigorously;

2) Mixture was de-gased thoroughly so that no trapped air bubbles were visible. This was done by using a light vacuum and allowing the ink to sit idle for more than 15 minutes;

3) Acetylene black was added in 0.5 gram increments and mixed;

4) Toulene was added in approximately in 5-10 gram increments until a slurry formed; and

5) Further mixing including stirring, ultrasonication, and shaking were used to ensure that the slurry was homogenous.

The insulating material was prepared by rigorously mixing the PDMS and curing agent and the mixture was de-gased thoroughly so that no trapped air bubbles are visible. This was done by using a light vacuum and allowing the ink to sit idle for more than 15 minutes.

The resulting conductive slurries and insulating layers were deposited sequentially to form a tri-layer structure, where each succeeding film conformably coats the last that was deposited. Similarly, the structure could be fabricated by depositing each of the conductive layers separately on two substrates and are then bonded together with a coating of the thin polymer material. If the substrates on which the materials are deposited on are non-adherent, the structure can be removed from the substrate and used as a stand-alone material. Likewise the material could be directly deposited conformably onto an existing surface.

Since all components can be deposited in the solution phase, it can be seen that fabrication of the structure can be conducted using a variety of low-cost, high-throughput deposition tools including screen-printing, extrusion printing, roll casting, spray coating, and dip coating. Using these processes, structures of varying sizes ranging from the millimeter to meter-scale could be fabricated, and patterns of varying intricacies are possible depending on the capabilities of the process. Thicknesses of each layer can be tailored, and so far for a 500 μm tri-layer structure, the material maintains a high level of durability and robustness even when mechanically stretched and bent.

One device fabrication process used to develop a stand-alone multilayer laminate was illustrated. First, a substrate material, (Kapton), was attached using removable tape to the flat surface of a glass panel. Two spacers, Kapton strips of known thicknesses, were attached with tape to the edges of the substrate. The spacers were used to guide the casting “blade” and ultimately determine the thickness of the casted film. Then the conductive slurry was poured onto the substrate spanning its width.

A casting “blade” in the form of a large flat panel of glass was placed on top of the substrate, conductive slurry, and spacers. The blade was slowly pulled along the length of the substrate, being guided by the two spacers. The resulting film was of similar thickness as the spacers and conformably coated the substrate. The resulting structure was dried in an oven. Temperatures up to 150° C. were used; however other temperatures and drying procedures can also be used.

After the first deposited film was dried, the insulating material was poured onto the surface and spanning its width. A casting blade was laid on top of the substrate, dried film, insulating solution, and spacers. The blade was slowly pulled along the length of the substrate, being guided by the two spacers to produce the center film of insulating material. The resulting structure is dried in an oven at a temperature of approximately 150° C. However other temperatures and drying procedures can be used.

After the insulating film was dried, the structure was cut into two pieces of mirroring shapes. On each piece, the side with an already dried insulating film was covered with insulating ink. This acted as glue to join the two pieces. A casting blade was placed on top of the substrate, dried film, insulating film, conductive slurry, and spacers. The blade was slowly pulled along the length of the substrate, being guided by the two spacers.

While the insulating films were still wet, the two pieces were joined together and then compressed to ensure that any air bubbles were removed. The resulting structure was dried in an oven at 150° C. However, other temperatures and drying procedures can be used.

Once the entire structure is dry, it can be used attached to the substrate material, or removed, becoming a stand-alone structure. Note that other deposition methods, substrate materials, and temperature procedures could be applied to achieve the same structure, and is not limited to planar structures. In one embodiment, extra insulating layers or other protective films can also be applied to the outside layers of the structure to shield the active conductive films.

### Example 2

The flexible bi-conductive material of the present invention can be used in a variety of fields including shielding, flexible capacitors, and strain gauges. As an illustration of a strain gauge configuration, a semiconductor-insulator-semiconductor composite structure with electrodes attached at the boundary was produced and tested.

The electrical properties of the material were sampled by applying currents and measuring resulting voltages at the boundary electrodes. The piezoresistive and geometry changes of the semiconductor layers results in resistance variations across the surface according to local curvature. Through sufficient sampling, a system of equations can be solved for the interior curvature properties. The local curvature data is integrated to yield an approximation of the surface shape.

The system preferably contains a single laminate sheet to reduce the requirements on wiring. While a single strain-gauge layer is sufficient for determining purely stretching modes of the sheet, a double strain-gauge layer is shown to be ideally suited for determining curvature of the sheet of material. The differential change in resistivity between the top and bottom layers is exploited to reduce common-mode noise and more accurately determine the curvature change of the sheet.

The sandwich of semiconductor and insulator layers of the bi-conductive sheet was produced to be highly flexible so that it can sit on cloth, for example, without adding excessive mechanical resistance. Elastomeric compounds and laminate dimensions are therefore preferred to provide flexibility and durability.

Sylgard® 184 polydimethylsiloxane (PDMS) was selected as the base polymer and insulative layer. The preferred recipe for carbon-loaded PDMS (cPDMS) consisted of 5:1 Acetylene Black:PDMS by weight, plus 7.5 mL toluene per gram of Acetylene Black. The cPDMS was first prepared, sonicated, and bladed across a Kapton sheet to ensure uniform thickness. The material was then cured in an oven for 2 hours at 100° C. Next, a layer of PDMS was bladed across the cured cPDMS and then cured. Finally, two squares of this material are cut and placed on each other. Another layer of PDMS was added between these two layers for bonding them and this sheet is completely cured. The sheet was then wired and prepared for testing.

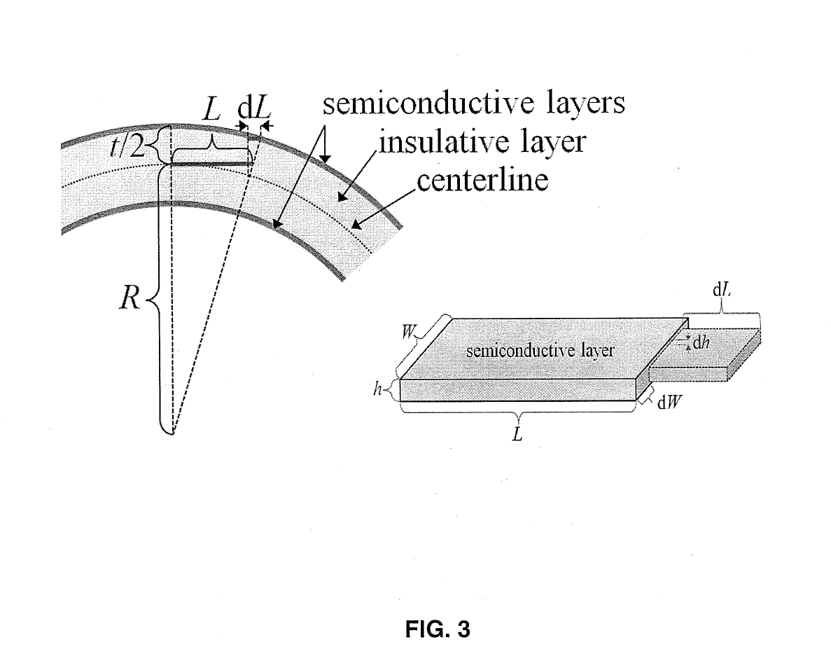

Referring now to the schematic of a bent bi-conductive sheet shown in FIG. 3, it can be seen that the bending of a layer of material results in the expansion of the material on one side and compression of the material on the opposite side. In FIG. 3, t is the total layer thickness, h is the semiconductor layer thickness (and h<<t), L is a unit length, W is a unit width, R is the radius of curvature, and K is the curvature. By convention, “d” before a symbol denotes the change in that quantity due to deformation, “δ” before a symbol, x, means dx/x, a subscript “L” or “W” after a quantity indicates its direction is either in the lengthwise or lateral direction respectively, and a superscript “T” or “B” after a quantity indicates it belongs to the top or bottom semiconductive surfaces respectively. By similar triangles, it is clear that for small amounts of bending, the strain in the lengthwise direction, ∈_{L}=dL/L, is related to R_{L}, K_{L}, and t as

$${ɛ}_{L} = δ L = \frac{dL}{L} = \frac{t}{2 {R}_{L}} = \frac{t}{2} {κ}_{L} .$$

Strain in one direction of the material typically results in deformation in the orthogonal directions according to Poisson's ratio, υ. Also the resistivity of the material, ρ, may change as a function of induced strain due to the piezoelectric effect that is usually linearized in a strain-gauge factor, G, as ρ′=ρ(1+G∈). Temperature effects are ignored in this analysis because they similarly affect the bottom and top layers.

A sheet of material can be subdivided according to an arbitrary internal grid will be useful in discretizing the real-valued resistance of the sheet in the L and W directions, [symbol] _{L} (x, y) and [symbol] _{W} (x, y), and relating those to local curvatures, κ_{L} (x, y) and κ_{W} (x, y). The local matrix equation for the top surface is:

$$[ \begin{matrix}δ {W}_{T}^{} \\ δ {L}_{T}^{}\end{matrix} ] = \frac{t}{2} [ \begin{matrix}( 1 + 2 υ + G ) - ( 1 + G υ ) \\ - ( 1 + G υ ) ( 1 + 2 υ + G )\end{matrix} ] [ \begin{matrix}{κ}_{W} \\ {κ}_{L}\end{matrix} ] .$$

Similarly, the bottom-surface resistance changes should be close to equal and opposite to the top-surface resistivity changes (δ [symbol] _{W}^{B}=−δ [symbol] _{W}^{T} and δ [symbol] _{L}^{B}=−δ [symbol] _{L}^{T}) even for differences in the thickness of the semiconductive-layer (h^{B}≠h^{T}) as long as the centerline of bending remains close to t/2.

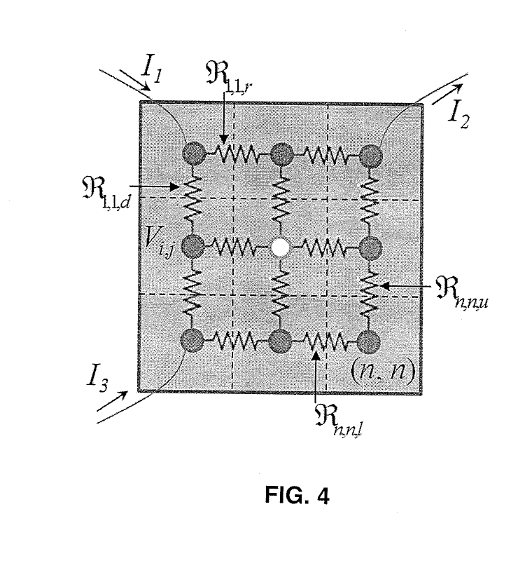

Referring also to FIG. 4, the sheet can be represented in an equivalent circuit as a regular grid of nodal points with lengthwise and lateral resistors. Nodal voltages are labeled V_{i,j}, i=1 . . . n , j=1 . . . n , and n is the number of boundary electrodes along a side (for simplicity it was assumed the same number in the horizontal and vertical directions). Additionally, the voltages will be different for every set of supplied boundary currents so an additional index, k, in V_{i,j,k} denotes the k^{th} current configuration. The resistances between nodes are represented as [symbol] _{i,j,u}, [symbol] _{i,j,l}, [symbol] _{i,j,r}, and [symbol] _{i,j,d} for the resistor above, to the left, right, and below node (i, j) respectively. The interior voltages are not initially known and must be solved for each set of supplied currents simultaneously with the resistances between nodes.

Due to the nonlinear nature of simultaneously solving for unknown voltages, currents, and resistances, a nonlinear fitting routine was employed that can be iteratively updated using the solution from the previous time step to reduce computational cost. A simplifying result is that once the initial resistances are solved, it is only necessary to solve for the change in resistances (δ [symbol] ) and it is known from prior analysis that the change in resistance of the top resistors should be negative or opposite of the change in the corresponding bottom resistors. Kirchhoff's Current Law (KCL) provides a set of equations that need to be satisfied at each nodal point—the currents into each node must be equal to the currents out of the node. For a given estimate of resistances and interior voltages, a non zero residual current, I_{i,j,k}^{res}, is the error where

$${I}_{i , j , k}^{res} = \frac{{V}_{i , j , k} - {V}_{i - 1 , j , k}}{{i , j , 1}_{}} + \frac{{V}_{i , j , k} - {V}_{i + 1 , j , k}}{{i , j , r}_{}} + \frac{{V}_{i , j , k} - {V}_{i , j + 1 , k}}{{i , j , d}_{}} + \frac{{V}_{i , j , k} - {V}_{i , j - 1 , k}}{{i , j , u}_{}}$$

The number of terms in this equation will depend on the location of the node (boundary, interior, or at the location of a supplied current). An additional constraint that may be enforced is the interior geometry. Assuming the sheet resistance is relatively uniform, an appropriate way to enforce geometry of the interior mesh is to also reduce the residuals 1/ [symbol] _{i,j,u}-1/ [symbol] _{i,j,d} and 1/ [symbol] _{i,j,l}-1/ [symbol] _{i,j,r}. Finally, additional residual terms can be added to aid in convergence of the chosen nonlinear fitting routine by not allowing resistances to grow too small or too large.

MATLAB's nlinfit program, which uses an algorithm based on Gauss-Newton with Levenberg-Marquardt modifications, was chosen as the nonlinear solver. The appropriate number of supplied sets of currents, K, is found from the number of unknowns in the system, 4n(n−1)+2K(n−2)², and the number of equations from KCL, 2Kn². A unique solution requires that K≧n/2 for large n; however, more sets are preferred to ensure robustness. The local curvature at each nodal location was then solved using the local matrix equation described above.

The final theoretical consideration was to provide solutions for determining global shape from local curvatures. The curvatures obtained at each node in the previous section describe the local behavior of the surface at that point. Given the curvature information and relative location of each node, the three-dimensional shape of the material can be obtained. Integration of local surface information to obtain a mesh representing the global surface was conducted in two steps. First, a local coordinate frame at each node point is constructed and then the transformation between that coordinate frame and those at the neighboring nodes is solved.

Therefore, the first step was to build a local surface patch at each node. By construction, the location of every node with respect to every other in the default configuration is known. It was assumed that the material does not shear as easily as it wrinkles and that the majority of the local curvature is due to out-of-plane motion and a local surface patch was built by integrating the local curvature inside the patch, while ensuring that the arclength between nodes stayed the same.

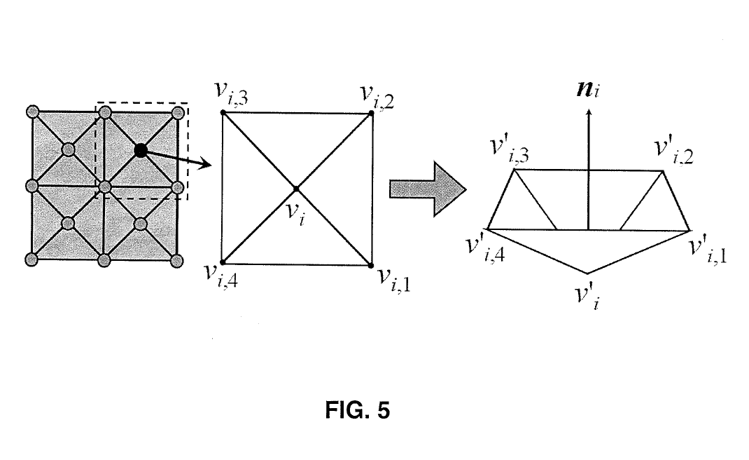

FIG. 5 illustrates how the node positions and normal vectors are updated using the local curvature information. For each topological node vᵢ, we consider its neighbors v_{i,j}. These neighbors define the neighborhood of vᵢ. The curvatures that are obtained are defined relative to the default configuration (as are the default neighboring node locations), which provides the ability to determine local surface shape by integrating the curvature along each edge from vᵢ to v_{i,j}. Essentially, we are bending the edge from vᵢ to v_{i,j} in the plane (v_{i,j}−vᵢ)×nᵢ (where nᵢ is the normal at vᵢ) such that it fits the curvature from the previous section, then representing the surface patch as vectors from vᵢ to the end point of the bent edge. We numerically integrate the patch curvature along each edge as out-of-plane deformation to compute the end point of the bent edge.

After performing this procedure for every node, a collection of local surface meshes has been obtained that needs to be oriented relative to each other to create a global surface mesh. To do this, note that nᵢ is known in the local surface mesh centered on vᵢ. In addition, can be determined, which is normal to vertex v_{i,j} expressed relative to nᵢ. From the edges and the normals, a coordinate frame can be built for vᵢ as well as a coordinate frame for v_{i,j} relative to vᵢ. At this point, the coordinate frames for each node have been determined as well as relative definitions of neighboring coordinate frames. A global surface mesh is obtained from integrating these relative coordinate frames.

A National Instruments USB-6259 data acquisition box was used to apply and measure voltages to the devices. Using van der Pauw's method, sheet resistance of a 110±10 μm thick cPDMS square (8 cm on a side) with corner electrodes was measured to be 814±16Ω (100 samples). The resistivity of the cPDMS layer is then 0.0895±0.0083 Ω·m giving a conductivity of 11±1 S·m⁻¹ and placing it within the range of other forms of carbon. Dopant concentrations could be added and would likely enhance the piezoresistive response; however without doping, negligible Gauge factor was assumed due to piezoresistivity except for that which may be inherent to a carbon loaded polymer matrix.

Two tests were performed on the bi-conductive sheet. In the first test, a linear curvature sensor was made using a single layer of the cPDMS embedded on a glove and compared with a linear curvature sensor made using a strip of the bi-conductive sheet. The single layer of cPDMS was probed using a voltage divider technique with a supplied voltage of 10 V and an external 1 MΩ resistor in series. The bi-conductive sheet was probed by supplying a 10 V signal to both ends and measuring the differential voltage drop at a point before the bend of the knuckle. In both cases, the strips were attached to the glove using PDMS. The plotted results were randomly selected and unprocessed voltages.

The second test was instrumenting a square piece of the sheet material with electrodes on the top and bottom surfaces in a square pattern. The wires were attached to the surface using cPDMS as the bonding agent. It was found that other fastening techniques such as soldering and using nickel-loaded PDMS were not as good in terms of durability and in decreasing contact resistance. The test used n=3 for the number of electrodes on a side. Three different current sets were cycled every 2 ms.

The sheet was also tested under multiple bending modes including bending the middle of the far edge of the sheet downwards and bending the far corner of the sheet upwards and off-axis. Applying these two bending modes tested whether the system could tell the difference between the two.

The initial resistances and voltages of the network were solved using nlinfit (the nonlinear fitting function MATLAB) on the equations from KCL. Thereafter, changes in resistances were solved using the fact that the change in the resistances of the top sheet would be equal and opposite to the corresponding change in resistances in the bottom sheet, or differ by a common factor, α, in the worst case (due to bending variations from the centerline as shown in FIG. 3). The α was a parameter solved for in the fitting routine. Local curvature was found by using these changes in resistances. From local curvature, the global shape was extracted. Finally, the extracted shape was compared with digital video taken of the sample being bent. The result shows conceptual agreement for both modes tested; however, there are some variations especially under large deformation as in the corner-bending case that resulted in exaggerated bending in the corner nodes.

These results show that a bi-conductive sheet has a higher signal-to-noise ratio (SNR) and lower drift than an equivalent single-layered sheet as well as more directly mapping to the curvature in the finger. In the single layer sheet, it was unclear how the voltage change relates to the curvature change in the finger and it demonstrated slow transient characteristics. It is likely that the drift is taken care of in the bi-conductive sheet by the differential voltage measurement. The correlated noise should also be reduced due to the differential pathway along the top and bottom conductive layers.

While the current approach for surface shape capture employs a black-box nonlinear solver, the efficiency of solving the system can be improved both by knowing resistivities ahead of time and accurately predicting the next resistivities based on the continuity of the changes. A more tailored nonlinear solver could also help improve the solution time.

Accordingly, this Example demonstrates surface shape capture using boundary electrodes connected to a flexible sheet containing two carbon loaded polymer layers separated by an insulating layer. The sensor was shown to be extremely durable and lightweight as well as inexpensive and easy to produce. Furthermore, the material is easy to apply to existing objects, such as a glove, or can be produced as a stand-alone sheet. In the one-dimensional case, the system is able to reliably detect the degree of actuation of a joint. Experiments showed that the multi-layer structure outperforms a single layer in terms of noise. In the two-dimensional case, the system is able to determine the approximate degree of curvature of a sheet of material and, in particular, with just a few electrodes reliably determine convex versus concave shape.

This type of sensor is ideally suited to detecting large deformations without being constraining or obtrusive. Because the material can be applied directly to existing devices, it is possible to create sensing surfaces even on curved devices such as monitoring the shape of sails. Another application is human behavioral and safety monitoring. In this case, the sensor can be embedded into clothing to provide data on the subject's actions. A combination of one and two-dimensional sensors can provide data used in discriminating actions and providing valuable feedback, as well as enabling the subject to interact with their digital environment through gestures.

From the discussion above it will be appreciated that the invention can be embodied in various ways, including the following:

1. A flexible laminate material, comprising: a first polymer conductive layer; an electrically insulating layer; and a second polymer conductive layer, wherein a surface of the first polymer layer and a surface of the second polymer layer are bonded to the insulating layer.

2. The material of embodiment 1, wherein the first conductive layer and the second conductive layer are made of conductive particles dispersed throughout a flexible polymer.

3. The material of embodiment 1, wherein the first conductive layer and the second conductive layer are made of semi-conductive particles dispersed throughout a flexible polymer.

4. The material of embodiment 2, wherein the conductive particles are selected from the group of particles consisting essentially of activated carbons, graphite, carbon nanotubes, and nanoparticles of zinc, silver, nickel, and nickel-coated carbon.

5. The material of embodiment 3, wherein the semi-conductive particles are selected from the group of particles consisting essentially of titanium dioxide and zinc oxide.

6. The material of embodiment 2, wherein the first conductive layer is made of a first type of conductive particles dispersed throughout a flexible polymer and the second conductive layer is made of a second type of conductive particles dispersed throughout a flexible polymer.

7. The material of embodiment 1, wherein each conductive polymer layer is formed from a polymer selected from the group of polymers consisting essentially of poly di-methyl silane (PDMS), polyvinylidene fluoride (PVDF), polytetrafluoroethylene (PTFE), polyvinyl alcohol (PVA), and cellulose.

8. The material of embodiment 2, wherein the flexible polymer of the conductive layers is also be used to form the insulating polymer layer.

9. The material of embodiment 1, wherein the insulating layer is made of nanoparticles of an electrical insulator dispersed throughout a flexible polymer.

10. The material of embodiment 9, wherein the insulating particles are selected from the group of particles consisting essentially of magnesium oxide, alumina, feldspar, clay and quartz.

11. The material of embodiment 2, wherein the weight ratio of polymer to conductive particles forming the first conductive layer or the second conductive layer is 4:1 or 5:1.

12. The material of embodiment 1, further comprising a protective layer disposed on the top of the first polymer conductive layer.

13. A flexible laminate material, comprising: a top protective layer; a first polymer conductive layer; an electrically insulating layer; a second polymer conductive layer, and a bottom protective layer wherein an inner surface of the first polymer layer and an inner surface of the second polymer layer are bonded to the insulating layer and an outer surface of each polymer conductive layer is bonded to a protective layer.

14. The material of embodiment 13, wherein the top protective layer and the bottom protective layer are made of a flexible electrically insulating polymer.

15. The material of embodiment 13, wherein the top protective layer and the bottom protective layer are made of a polymer selected from the group of polymers consisting essentially of poly di-methyl silane (PDMS), polyvinylidene fluoride (PVDF), polytetrafluoroethylene (PTFE) and polyvinyl alcohol (PVA).

16. The material of embodiment 13, wherein the first conductive layer and the second conductive layer are made of conductive particles dispersed throughout a flexible polymer.

17. The material of embodiment 16, wherein the conductive particles are selected from the group of particles consisting essentially of activated carbons, carbon nanotubes, and nanoparticles of zinc, silver, nickel, and nickel-coated carbon.

18. The material of embodiment 13, wherein each conductive polymer layer is formed from a polymer selected from the group of polymers consisting essentially of poly di-methyl silane (PDMS), polyvinylidene fluoride (PVDF), polytetrafluoroethylene (PTFE) and polyvinyl alcohol (PVA), and cellulose.

19. The material of embodiment 13, wherein the insulating layer is made of nanoparticles of an electrical insulator dispersed throughout a flexible polymer.

20. The material of embodiment 19, wherein the insulating particles are selected from the group of particles consisting essentially of magnesium oxide and alumina, feldspar, clay and quartz.

21. The material of embodiment 13, wherein the weight ratio of polymer to conductive particles forming the first conductive layer or the second conductive layer is 4:1 or 5:1.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A flexible laminate material, comprising:
a first polymer conductive layer;
an electrically insulating layer; and
a second polymer conductive layer,
wherein a surface of the first polymer layer and a surface of the second polymer layer are bonded to the insulating layer.

2. A material as recited in claim 1, wherein the first conductive layer and the second conductive layer are made of conductive particles dispersed throughout a flexible polymer.

3. A material as recited in claim 1, wherein the first conductive layer and the second conductive layer are made of semi-conductive particles dispersed throughout a flexible polymer.

4. A material as recited in claim 2, wherein the conductive particles are selected from the group of particles consisting essentially of activated carbons, graphite, carbon nanotubes, and nanoparticles of zinc, silver, nickel, and nickel-coated carbon.

5. A material as recited in claim 3, wherein the semi-conductive particles are selected from the group of particles consisting essentially of titanium dioxide and zinc oxide.

6. A material as recited in claim 2, wherein the first conductive layer is made of a first type of conductive particles dispersed throughout a flexible polymer and the second conductive layer is made of a second type of conductive particles dispersed throughout a flexible polymer.

7. A material as recited in claim 1, wherein each conductive polymer layer is formed from a polymer selected from the group of polymers consisting essentially of poly di-methyl silane (PDMS), polyvinylidene fluoride (PVDF), polytetrafluoroethylene (PTFE), polyvinyl alcohol (PVA), and cellulose.

8. A material as recited in claim 2, wherein the flexible polymer of the conductive layers is also be used to form the insulating polymer layer.

9. A material as recited in claim 1, wherein the insulating layer is made of nanoparticles of an electrical insulator dispersed throughout a flexible polymer.

10. A material as recited in claim 9, wherein the insulating particles are selected from the group of particles consisting essentially of magnesium oxide, alumina, feldspar, clay and quartz.

11. A material as recited in claim 2, wherein the weight ratio of polymer to conductive particles forming the first conductive layer or the second conductive layer is 4:1 or 5:1.

12. A material as recited in claim 1, further comprising a protective layer disposed on the top of the first polymer conductive layer.

13. A flexible laminate material, comprising:
a top protective layer;
a first polymer conductive layer;
an electrically insulating layer;
a second polymer conductive layer, and
a bottom protective layer
wherein an inner surface of the first polymer layer and an inner surface of the second polymer layer are bonded to the insulating layer and an outer surface of each polymer conductive layer is bonded to a protective layer.

14. A material as recited in claim 13, wherein the top protective layer and the bottom protective layer are made of a flexible electrically insulating polymer.

15. A material as recited in claim 13, wherein the top protective layer and the bottom protective layer are made of a polymer selected from the group of polymers consisting essentially of poly di-methyl silane (PDMS), polyvinylidene fluoride (PVDF), polytetrafluoroethylene (PTFE) and polyvinyl alcohol (PVA).

16. A material as recited in claim 13, wherein the first conductive layer and the second conductive layer are made of conductive particles dispersed throughout a flexible polymer.

17. A material as recited in claim 16, wherein the conductive particles are selected from the group of particles consisting essentially of activated carbons, carbon nanotubes, and nanoparticles of zinc, silver, nickel, and nickel-coated carbon.

18. A material as recited in claim 13, wherein each conductive polymer layer is formed from a polymer selected from the group of polymers consisting essentially of poly di-methyl silane (PDMS), polyvinylidene fluoride (PVDF), polytetrafluoroethylene (PTFE) and polyvinyl alcohol (PVA), and cellulose.

19. A material as recited in claim 13, wherein the insulating layer is made of nanoparticles of an electrical insulator dispersed throughout a flexible polymer.

20. A material as recited in claim 19, wherein the insulating particles are selected from the group of particles consisting essentially of magnesium oxide and alumina, feldspar, clay and quartz.

21. A material as recited in claim 13, wherein the weight ratio of polymer to conductive particles forming the first conductive layer or the second conductive layer is 4:1 or 5:1.
